(19) United States
(12) Patent Application Publication
(10) Pub. No.: US 2021/0342882 A1
(43) Pub. Date: Nov. 4, 2021

(54) SYSTEM AND METHOD FOR MEASURING ADVERTISING PERFORMANCE ACROSS MULTIPLE PLATFORMS

(71) Applicant: MiQ Digital USA Inc., New York, NY (US)

(72) Inventors: Shamshu Dharwez Saganvali, New York, NY (US); Matthew Sotebeer, New York, NY (US)

(73) Assignee: MiQ Digital USA Inc.

(21) Appl. No.: 17/307,102

(22) Filed: May 4, 2021

Related U.S. Application Data
(60) Provisional application No. 63/019,594, filed on May 4, 2020.

(51) Int. Cl. G06Q 30/02

(52) U.S. Cl. CPC G06Q 30/0246; G06Q 30/0257; G06Q 30/0272; G06Q 30/0255; G06Q 30/0201

(57) ABSTRACT

A system and method for tracking user activity across multiple advertising domains, including both off-site and on-site user activity. The present methods employ at least a first creative pixel associated with an ad exposure to obtain a unique ID for the user and capture user activity data associated with this unique ID. The unique ID assigned to the user is the same regardless of which advertising platform serves the ad. The present methods further employ at least a first site pixel associated with content provided by the advertiser to receive the unique ID for a visitor to the website which has previously been exposed to one or more advertisements on off-site websites. The use of a common unique ID for on-site and off-site activity, regardless of platform, enables sophisticated analytics of advertising performance across multiple advertising platforms.

### CROSS-REFERENCE TO RELATED APPLICATION(S)

This application relates to and claims priority from U.S. Provisional Patent Application No. 63/019,594, filed on May 4, 2020, the entire disclosure of which is incorporated herein by reference.

### BACKGROUND

### Field of the Disclosure

The present disclosure relates generally to the field of advertising and more particularly relates to tracking advertiser performance across multiple domains on a computer network.

### Description of the Related Art

In the field of advertising, it is highly desirable to be able to track and measure consumer behavior from the point of ad exposure through some measurable action by the consumer. Understanding this consumer behavior allows advertisers to modify advertising content and delivery channels to maximize response and conversion rates to derive the most value from the cost of the ad. For ad publishers, the data allows improved pricing and performance based pricing models. For example, a simple performance based metric for an online advertisement may be for the advertiser to pay the publisher each time a viewer clicks on the advertisement to visit the advertiser's webpage. Additional performance metrics may include payment for actual conversions, i.e., purchases resulting from displaying the advertisement. These performance models are typically measured using a consumers “click-through” on a displayed ad.

Known methods for tracking post ad exposure activity in online advertising absent actual click-throughs include the use of “cookies” or tracking “pixels.” A cookie is a small piece of software code that is stored on a user's computer web browser and is used by web servers to store data related to specific user activity. Cookies can be used for improving user convenience, such as storing log in credentials or preferences for a particular website. Cookies can also be used for tracking user behavior. For example, a cookie can track the URLs of websites visited by the user after exposure to an advertisement. To protect user privacy, cookies typically do not store or transfer personally identifiable information (PII). Rather, for evaluating ad response, an ad server will assign a unique ID to the cookie. In this way, while the identity of the user is not known, all of the activity within a particular domain associated with a specific user is linked to that unique ID. In this way, the behavior of the user can be understood by an advertiser without compromising user privacy.

Pixels, or pixel tags, like cookies, are small pieces of software code. The code in a pixel tag is typically contained within a single pixel transparent GIF image file that is added to the webpage being served to the user. Rather than residing on a user's computer browser, pixel tags are passed to the user from a server when a webpage is displayed. While the main content of the webpage is generally served from the website's domain server, the pixel is typically served by the domain-specific ad server. In this context, domain-specific refers to ads published by a specific ad server, such as a particular social network or search engine advertising network. The pixel, which passes data to the ad server, allows the ad server to track the user activity within the particular domain. Pixels can be programmed to respond or “fire” in response to certain user activity, such as requesting certain content or responding to certain content displayed on the web pager, by sending back user activity data to the server.

With pixels, the ad server typically assigns a domain-specific unique ID to the user whose computer displayed the pixel. This allows the ad server to collect data and track activity associated with that user without transferring personally identifying information. For example, an advertiser distributing ads on a social network platform may elect to use that network's proprietary tracking pixel. When the advertiser's advertisement is displayed to a user, the tracking pixel served by the social network's ad server may fire indicating that the ad was published. If the user hovers over the advertisement with her cursor, that may also cause the pixel to fire indicating that the advertisement received user attention. If the user takes further action, such as clicking on the ad, this activity could also cause the pixel to fire so that this data is also provided to the ad server. In each case, the data provided by the pixel is associated with a domain-specific user ID that was assigned by the social network's ad server so that all activity for this user on the social network domain is collated into a user profile.

Although current systems employing pixels and cookies allow for some tracking of user activity, these systems still suffer several limitations. For example, since cookies reside on a user's computer they are susceptible to being blocked by a user or deleted by the user. Further, known systems using pixels are limited to tracking activity within a particular ad server's domain, such as a specific social media network or search engine advertising platform, preventing a comprehensive view of advertising effectiveness across multiple advertising platforms.

### SUMMARY OF THE DISCLOSURE

A method for tracking viewer activity in response to advertising includes serving an advertisement to a user device requesting content from a third party website and serving a creative pixel associated with the advertisement to the user device. The creative pixel initiates a request to a device graph server to assign a unique identifier to the user device receiving the advertisement. The creative pixel associates the unique identifier with user activity on the third party website and passes the associated activity data to an agency server which maintains a record of activity associated with the unique identifier.

The method can also tracks on-site user activity, or activity on, or associated with, an advertiser's website. For example, in response to a request for content for an advertiser website, the requested content is provided to the user along with a site pixel associated with that content. The site pixel initiates a request to the device graph server for the unique identifier of the user and the device graph server returns the unique identifier in response to the query. Since the unique identifier is device/user specific, if the user was previously provided with a unique identifier in response to a query from a creative pixel, the same unique identifier will be returned in response to the query from the site pixel. The site pixel associates user activity data on the advertiser website with the unique identifier and passes the associated website activity data to the agency server to include in the record of activity associated with the unique identifier.

In another exemplary embodiment, a method for tracking on-site and off-site viewer activity on a computer network in response to advertising exposure is provided. The method may include serving an advertisement to a user requesting content from a third party website and serving a creative pixel associated with the advertisement to the user. The creative pixel can be capable of initiating a request to a device graph server to assign a unique identifier to the user, associating the unique identifier with user activity on the third party website, and passing the associated activity data to an agency server to generate a record of activity associated with the unique identifier. The method may further provide that in response to a request for content on an advertiser website by the user, a site pixel associated with the content can be fired. The site pixel is capable of initiating a request to the device graph server for the unique identifier of the user, receiving the unique identifier therefrom, and associating user activity data on the advertiser website with the unique identifier and transmitting the associated website activity data to the agency server to include in the record of activity associated with the unique identifier.

The creative pixel may be activated in response to specified off-site activity by the user. For example, the off-site user activity may include hovering over the advertisement, clicking on the advertisement, conducting a search related to the advertisement, or entering a URL related to the advertisement.

Preferably, the unique identifier is generated without the use of personally identifiable information. Moreover, in the present methods, advertisements can served to the user on third party websites on multiple domains and, preferably, the unique identifier assigned to the user is the same regardless of advertising domain.

In another exemplary embodiment, a method of measuring advertising performance on a computer network is provided. The method includes providing a creative pixel associated with advertising content, the creative pixel being used to provide off-site data related to user activity on a third party website and a unique identifier associated with the user to an agency server. The method further provides on-site data related to user activity on the advertiser's website and the unique identifier associated with the user is provided by a site pixel associated with the advertiser's website. The method can use the unique identifier associated with the user to associate a user's off-site activity on third party websites and on-site activity on the advertiser's website. Preferably, the off-site data includes user data related to activity across a plurality of advertising domains. An analytics engine can be applied to the on-site and off-site data to evaluate the performance of advertising content.

The unique identifier may be generated in response to a request from the creative pixel. In certain embodiments, the unique identifier is associate with a specific user across multiple devices. Preferably, the unique identifier is not associated with personally identifiable information of a user.

The offsite activity can include various information of interest in evaluating advertising performance. For example, it may include whether a user hovered over an advertisement, whether a user clicked on an advertisement, a viewing time associated with the advertisement, and post ad exposure activity such as specific page views by the user following exposure to an advertisement, searches performed related to the advertisement or navigation to a URL related to an advertisement.

Similarly, on-site activity, that is activity of a user on an advertiser's website, can also include various information of interest in evaluating advertising performance. This can include on-site page views, viewing times associated with the page views by the user, and shopping cart activity by the user, such as adding items to a shopping cart, removing items from a shopping cart, purchasing items added to shopping cart, and abandoning items in a shopping cart. The onsite data can also data on completed transactions performed by the user.

The analytics engine can correlate off-site user activity to subsequent on-site user activity to determine a measure of effectiveness of an advertisement. In one example, the off-site data can include advertising parameters for different advertisements within a campaign and the analytics engine determines relative measures of effectiveness of the advertisements. In another example, the off-site data can include advertising parameters for an advertisement published across multiple domains and the analytics engine can determine relative measures of effectiveness of the advertisement on each domain.

Another example of the present systems and methods includes an advertising computer server system for use on a computer network. The server system includes one or more computer processors, computer storage, and network interfaces to operate on a computer network, such as the internet. The computer server system includes a first software module providing a creative shell to a third party website on the computer network for publication of an advertisement, the creative shell including a creative shell pixel. The computer server system can also include a device graph database system providing an association between a user and a unique identifier for the user. The computer server system further includes a second software module to receive a request from the creative shell pixel for assignment of a unique identifier of a user and applying the device graph to assign the unique identifier to the user. The computer server system further includes a third software module to receive a request from a site pixel embedded on an advertiser website to return the previously assigned unique identifier assigned to a user to the advertiser website, whereby a user activity on the third party website can be associated with subsequent user activity on the advertiser website.

Using a robust record of on-site and off-site activity associated with the unique identifier, which is common to the user regardless of domain, the agency server can develop robust analytics related to advertising effectiveness across different ads and ad delivery platforms.

### BRIEF DESCRIPTION OF THE FIGURES

FIG. 1 is a system level diagram illustrating the current system and method for tracking user activity across multiple on-site and off-site domains.

FIG. 2 is a flow chart illustrating an example of the steps performed in the current method for tracking user activity across multiple on-site and off-site domains.

FIG. 3 is a simplified block diagram illustrating the system level operation of the present method of tracking user activity across multiple platforms.

### DETAILED DESCRIPTION

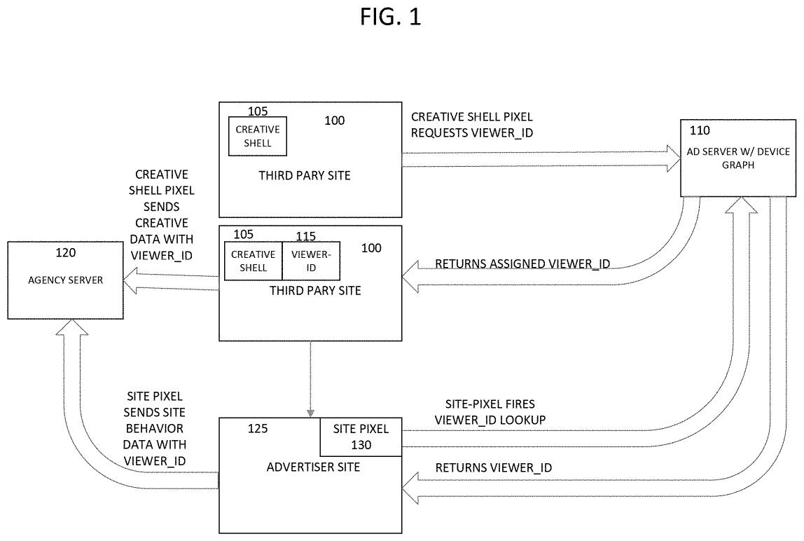

FIG. 1 is a high-level system block diagram illustrating the operation of the current systems and methods for tracking user activity, both on-site and off-site, in response to an advertisement across multiple domains. In connection with the present disclosure, the term “on-site” generally refers to pages on the website of the advertiser, e.g., the destination website for consumers being targeted by the advertising. The term “off-site” refers to a wide array of third party websites and platforms on which advertising may be published to viewers. For example, a tool company, “TOOLCO,” may have a website at www.TOOLCO.com and pay to have advertisements served on popular social networks, such as Facebook®, and through a search engine network, such as Google Ads® on various third party websites. The various webpages on www.TOOLCO.com domain, e.g. www.toolco.com\product_1, are examples of on-site webpages and the websites where the advertisements are being served are examples of off-site webpages.

The system and methods described herein are generally deployed on a computer network, such as the internet, and controlled by an advertising agency entity which coordinates the distribution of advertisements for an ad campaign and prepares analytics of an advertisers advertising campaign to measure results. To perform online advertising management functions, the advertising agency has one or more computer servers, Agency Server 120.

Referring to FIG. 1, a user, having a device such as a computer, smartphone, or tablet, visits a third party website 100 of interest, e.g., WWW.TOOLUSER.COM. TOOLCO wishes to advertise to TOOLUSER.COM readers and a TOOLCO advertisement is provided by Ad Server 110 to the user computer when visiting the third party website 115. The advertisement content, referred to as the advertising creative, can be fixed content or dynamic content and is typically defined within a creative shell 105 which specifies the content and display properties of the advertisement to be displayed on the third party website 100. When a user requests a page from TOOLUSER.COM, that page will be displayed on the user computer along with the advertisement defined in the creative shell 105. The creative shell 105 has an associated creative shell pixel that fires when the advertising content is displayed. The creative shell pixel firing initiates a request to the ad server 110 for a unique Viewer_ID for the user.

The Ad Server, which can be provided by a third party service provider, such as Google, Facebook, Amazon and the like, includes a database with a device graph table that allows the Ad Server to recognize a specific user computer based on received machine attributes or parameters. The device graph typically makes this association without using personally identifying information. Through the device graph, the Ad Server can uniquely identify each user. Although the functionality of assigning the Viewer_ID is shown within Ad Server 110, since this is typically where device graphs are maintained, it will be appreciated that this functionality can reside on any server which maintains a suitable device graph. Moreover, even if the device graph function is maintained on a third party Ad Server, the present system and method will use this same server to provide the Viewer_ID even when that third party is not providing the specific ad in question. Thus, the functionality associated with generating and providing the Viewer_ID can more broadly be described as a device graph server where the ID resolution process takes place.

In connection with the current systems and methods, the Ad Server will maintain a table in the database that associates each user with a unique Viewer_ID based on the device graph and its associated ID resolution algorithms. In response to the request from the creative shell pixel, the Ad Server will pull the unique assigned Viewer_ID from the table and return this Viewer_ID 115 to the creative shell pixel. The creative shell pixel can append this Viewer_ID to all user activity associated with the creative shell that is reported to an Agency Server 120, which maintains a database to collect and analyze the user activity to evaluate advertising effectiveness.

Off-site activity can include nearly any detectable user activity on the third-party website, such as whether the user hovered over the advertisement with a mouse, whether the user clicked on the advertisement, whether the user conducted a search related to the advertisement, and whether the user entered a URL related to the advertisement. The off-site activity may also include the length of time a user spent reading or otherwise interacting with an advertisement.

After a user is exposed to an advertisement, that user may or may not choose to take action at that time. For example, in response to seeing a TOOLCO ad, the user may click on a link to the ad and be directed to page on www.TOOLCO.com. In this case, the redirection can be readily tracked by the creative shell pixel. Because the creative shell pixel is associated with content displayed on a specific third party webpage, once the user navigates to a different website, the creative shell pixel does not “follow” the user and no longer has the ability to track user behavior. This includes subsequent on-site activity by the user. For example, if after being exposed to a TOOLCO ad on TOOLUSER.COM the user does not take any immediate action, but takes mental note of the ad and at some later time navigates to the TOOLCO website, this activity would not be trackable by a conventional pixel or the present creative shell pixel. The present system and method, however, allows this activity to be captured by the agency server 120.

In the present system and method, one or more pages, and preferably all pages, on the advertiser site 125 are rendered with one or more Site Pixels 130. When a user navigates to an on-site webpage on the advertiser site 125, a Site Pixel 130 will fire which causes a request to be made to the Ad Server 110 to associate the user with a unique Viewer_ID. The Ad Server 110 uses the same device graph described above with respect to the inquiry by the creative shell pixel to read the Viewer_ID table and determine the Viewer_ID. This Viewer_ID can be used to track all on-site activity by the user. Further, if a user was assigned a Viewer_ID when visiting a third party web site 100 that served a relevant advertisement, this same unique Viewer_ID will be returned in response to the inquiry by the Site Pixel 130. The Site Pixel(s) associates the Viewer_ID with the on-site activity of the user and transmits this activity to the Agency Server 120. Using the Viewer_ID, for users that have engaged in both on-site and off-site activity, the Agency Server 120 can associate the off-site and on-site activity of a user to develop more effective and insightful analytics of the performance of various advertisements.

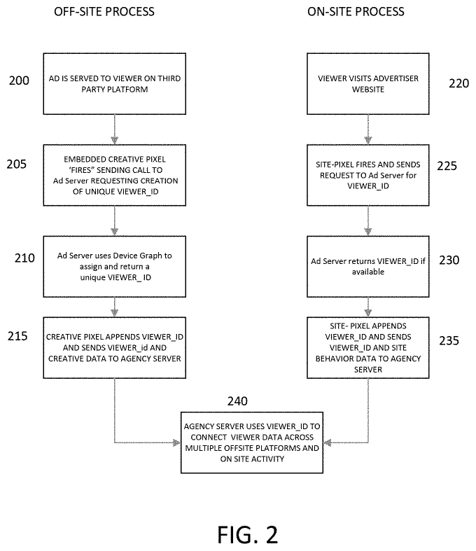

FIG. 2 is a flow chart further illustrating the present methods of tracking advertising performance including both on-site and off-site user activity. The off-site process begins with an advertisement being served to a visitor on a third party website in block 200. The advertisement is associated with a creative pixel that is rendered on the user's display along with the advertisement. In block 205, the creative pixel “fires,” sending user data to an Ad Server and requesting assignment of a unique Viewer_ID. In block 210, the Ad Server, using a device graph, determines if a Viewer_ID has been previously created for the associated user device and, if not, creates a unique Viewer_ID. In either case, the Ad Server responds to the inquiry from the creative pixel by returning the Viewer_ID. The creative pixel receives the Viewer_ID, appends this unique identifier to the creative data associated with the advertisement, and transmits this data to the Agency Server in block 215. The Agency Server can now maintain a database of all activity it receives for that particular Viewer_ID. Although blocks 200-215 are illustrated once, it will be appreciated that this process is repeated each time that an advertisement within a campaign is served. For example, if the user visits TOOLUSER.COM and is served a first ad from TOOLCO and later visits WOODWORKER.COM and is served a second ad from TOOLCO, these separate visits to different third party websites will be tracked by the Agency Server using the unique Viewer_ID assigned to, or associated with, that specific user.

The term “specific user” as used in this disclosure does not necessarily refer to a specific person or a specific computing device. The scope of the term “specific user” in a specific embodiment may be dependent on the sophistication of the device graph being employed. For example, a device graph may be limited to recognizing a specific computing device and assigning a unique identifier to that device. This may or may not correspond to single person as multiple people may share that device. Also, a more sophisticated device graph may be able to group several computing devices to a single “user.” For example a tablet, a cell phone, and a home computer may be recognized as belonging to the same “user” by a sophisticated device graph and the device graph server may return the same unique identifier to any of these devices providing a richer data set for the user.

When a viewer navigates to a webpage on the advertiser's website at block 220 the on-site process is initiated. When the particular webpage on the advertiser's website is being served to the user, a Site Pixel for that page is also served. The Site Pixel fires and sends a request to the Ad Server for a Viewer_ID in block 225. Since the same device graph is used, the Viewer_ID is the same unique identifier that would be assigned to this user in response to a query from the Creative Pixel. The Site Pixel associates this Viewer_ID with the on-site data of the user and transmits this data to the agency server. Since the Viewer_ID is a unique identifier that is common across all domains, including on-site and off-site activity, the Agency Server can provide a logical connection between all activity across multiple platforms and generate more meaningful advertising performance metrics.

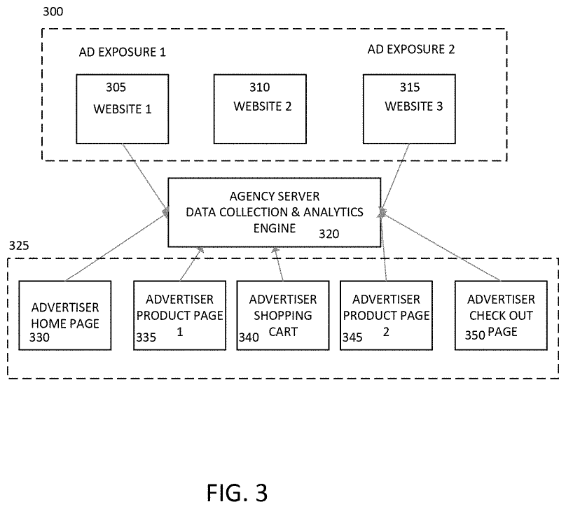

FIG. 3 summarizes the operation of the present systems and methods with an exemplary user experience having both off-site activity 300 and on-site activity 325 being collected for analysis by Agency Server 320. The device graph server or ad server are not shown in FIG. 3 but the functionality thereof is described above in connection with FIGS. 1 and 2. Off-site activity includes the various websites visited by a user in which advertisements may be delivered to the user. For example, website 1 305 may be a social network site and advertisements may be included within the users network feed. If an ad from a participating advertiser is served to the user, this results in ad exposure 1. As described above, the participating advertisement will have an associated creative pixel that queries an ad server having a device graph that assigns a unique ID to the user and returns this unique ID to the creative pixel. The creative pixel associated with ad exposure 1 transmits the activity and unique ID to the agency server 320 which maintains a database of this activity.

After visiting the website 1, the user may navigate to website 2. In the example of FIG. 3, there are no relevant ads served and no data is collected by agency server 320 when website 2 is visited. The user then visits website 315 and is delivered an ad for the same participating advertiser, identified as ad exposure 2. The ad can be the same as the first ad, or it can have different content, formatting, size, etc. A creative pixel associated with ad exposure 2 “fires” and sends a request to the device graph server for a unique ID associated with the user. Since this user has previously been assigned a unique ID based on ad exposure 1, the device graph server returns this previously assigned unique ID in response to the inquiry. The creative pixel associates the unique ID with the data from ad exposure 2, e.g., creative content, ad size, ad type, etc., to the agency server 320 to add to the record associated with the unique ID for the user. Significantly, the same unique ID is associated with the user regardless of which off-site platform resulted in the relevant ad exposure.

At some point during navigation, the user navigates to the advertiser's website 325 beginning the on-site experience. Preferably, each page which can be reached by a user on the advertiser's website includes one or more site pixels associated therewith so that user's entire experience on the advertiser's website can be captured. For example, perhaps the user first navigates to the advertiser's home page 330. This may result in a first site pixel firing, resulting in a query to the device graph server for the unique ID of the user. If, as in the example in FIG. 3, the user has been previously exposed to one or more relevant ads for this advertiser, the site pixel receives the unique ID that was previously assigned to that user in response to the query. The site pixel then associates a home page view with the unique ID and passes this data to the agency server 320. Perhaps the user then navigates to a specific product page on the advertiser's website, e.g. product page 1 335. This page will also have a site pixel that again associates this on-site activity with the unique ID and passes this data to the agency server 320. If the user wishes to add an item to a shopping cart 340 on the website, this can trigger yet another site pixel that allows this conversion activity associated with the unique ID to be passed to the agency server 320. The same process can be followed for each page visited on the advertiser website, such as product page 2 345 and the advertisers check out page 350 reflecting that a transaction was completed.

By analyzing the off-site activity across different platforms and subsequent on-site user activity, the Analytics Engine, preferably within the agency server 320, can provide detailed analytics comparing the performance of ads on different platforms. The specific analytics can be tailored to the specific advertising campaign to evaluate metrics of interest to the advertiser. For example, the data may show that users who are exposed to ads on website 3 are more likely to purchase than those exposed to the same ad on website 1. The data may show that an advertisement inserted within a social media feed on website 1 is more effective than a banner ad placed on any other website, or vice versa. The data can also illustrate user behavior on the advertiser's website following exposure to certain ads. Does the customer visit multiple product pages? Does the customer place an advertised product in the cart and do they complete the transaction? Does the customer start shopping by looking at an advertised product but then move on to a different product? Using the Analytics Engine, this on-site experience can be analyzed relative to the ad exposure and other off-site activity that was gathered by the creative pixels being deployed across multiple advertising platforms giving advertisers and advertising agencies deeper insight into the efficacy of different ad formats and ad platforms for specific campaigns. Since the cost for each ad exposure is also known, the cost effectiveness of various ads and ad platforms can also be compared. With this information, ad spending can be optimized for maximum value.

It will be appreciated that the Analytics Engine used by the Ad Agency and Ad Agency Server 320 may be performed by machine based analytics engines, manual processes, or any combination thereof. Machine learning tools and artificial intelligence software may preferably be employed, especially as more data is collected for a specific advertising campaign. In certain exemplary embodiments, the output from the analytics engine can then be used to evaluate the performance of various ads and ad placements and adjust the campaign in real time to improve advertising performance.

The present systems and methods can be implemented on general purpose computers programmed to perform the methods described herein. It will be understood that computer servers include the necessary processing, memory, and interface components to facilitate communication over a computer network, such as the internet, and the features and construction of these systems are generally well known in the art.

It is appreciated that in order to practice the systems and methods described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the current embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Any suitable programming language may be used in accordance with the various embodiments. Illustratively, the programming language used may include assembly language, Ada, APL, Basic, C, C++, Python, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

It will be readily understood by those persons skilled in the art that the present invention is susceptible to broad utility and application. Many embodiments and adaptations of the present embodiments other than those herein described, as well as many variations, modifications and equivalent arrangements, will be apparent from or reasonably suggested by the present embodiments and foregoing description thereof, without departing from the substance or scope of the invention.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed:

1. A method for tracking on-site and off-site viewer activity on a computer network in response to advertising exposure comprising:
serving an advertisement to a user requesting content from a third party website;
serving a creative pixel associated with the advertisement to the user, the creative pixel being capable of:
initiating a request to a device graph server to assign a unique identifier to the user,
associating the unique identifier with user activity on the third party website, and;
passing the associated activity data to an agency server to generate a record of activity associated with the unique identifier;
in response to a request for content on an advertiser website by the user, firing a site pixel associated with the content, the site pixel capable of:
initiating a request to the device graph server for the unique identifier of the user,
receiving the unique identifier therefrom, and
associating user activity data on the advertiser website with the unique identifier and transmitting the associated website activity data to the agency server to include in the record of activity associated with the unique identifier.

2. The method of claim 1, wherein the creative pixel is activated in response to specified activity by the user.

3. The method of claim 1, wherein the associated user activity includes at least one of hovering over the advertisement, clicking on the advertisement, conducting a search related to the advertisement, or entering a URL related to the advertisement.

4. The method of claim 1, wherein the unique identifier is generated without the use of personally identifiable information.

5. The method of claim 1, wherein advertisements are served to the user on third party websites on multiple domains and the unique identifier assigned to the user is the same regardless of advertising domain.

6. A method of measuring advertising performance on a computer network comprising:
from a creative pixel associated with advertising content, receiving off-site data related to user activity on a third party website and a unique identifier associated with the user;
from a site pixel associated with an advertiser's web page, receiving on-site data related to user activity on the advertiser's website and the unique identifier associated with the user;
using the unique identifier associated with the user, associating a user's offsite activity on third party websites and on-site activity on the advertiser's website; and
analyzing the on-site and off-site data to evaluate the performance of advertising content.

7. The method of claim 6, wherein the offsite data includes user data related to activity across a plurality of advertising domains.

8. The method of claim 6, wherein the unique identifier is generated in response to a request from the creative pixel.

9. The method of claim 6, wherein the unique identifier is associate with a specific user across multiple devices.

10. The method of claim 6, wherein the unique identifier is not associated with personally identifiable information of a user.

11. The method of claim 6, wherein the offsite activity includes specific page views by the user following exposure to an advertisement.

12. The method of claim 11, wherein the offsite activity includes a viewing time associated with the page views by the user on each page.

13. The method of claim 6, wherein the on-site activity includes specific page views on the advertiser website by the user.

14. The method of claim 6, wherein the on-site activity includes shopping cart activity by the user.

15. The method of claim 14, wherein the shopping cart activity includes at least one of adding items to a shopping cart, removing items from a shopping cart, purchasing items added to shopping cart, and abandoning items in a shopping cart.

16. The method of claim 6, wherein the on-site activity includes data on completed transactions performed by the user.

17. The method of claim 6, wherein the analysis correlates off-site user activity to subsequent on-site user activity to determine a measure of effectiveness of an advertisement.

18. The method of claim 17, wherein the off-site data includes advertising parameters for different advertisements within a campaign and the analysis determines relative measures of effectiveness of the advertisements.

19. The method of claim 18, wherein the off-site data includes advertising parameters for an advertisement published across multiple domains and the analytics engine determines relative measures of effectiveness of the advertisement on each domain.

20. An advertising computer server system for use on a computer network comprising:
a first software module providing a creative shell to a third party website on the computer network for publication of an advertisement, the creative shell including a creative shell pixel;
a device graph database system providing an association between a user and a unique identifier for the user;
a second software module to receive a request from the creative shell pixel for assignment of a unique identifier of a user and applying the device graph to assign the unique identifier to the user; and
a third software module to receive a request from a site pixel embedded on an advertiser website to return the previously assigned unique identifier assigned to a user to the advertiser website, whereby a user activity on the third party website can be associated with subsequent user activity on the advertiser website.
